(19) United States
(12) Patent Application Publication
(10) Pub. No.: US 2019/0130515 A1
(43) Pub. Date: May 2, 2019

(54) DYNAMIC AUTONOMOUS SCHEDULING SYSTEM AND APPARATUS

(71) Applicant: OPTIBUS LTD, Netanya (IL)

(72) Inventor: Amos HAGGIAG, Netanya (IL)

(21) Appl. No.: 16/087,380

(22) PCT Filed: Feb. 28, 2017
(86) PCT No.: PCT/IL2017/050257

§ 371 Date: Sep. 21, 2018

Related U.S. Application Data
(60) Provisional application No. 62/300,902, filed on Feb. 28, 2016.

(51) Int. Cl. G06Q 50/30; G01C 21/34; G01C 21/36; G05D 1/02; G05D 1/00; G07C 5/02; G08G 1/00; G07C 5/08

(52) U.S. Cl. CPC G06Q 50/30; G01C 21/3484; G01C 21/362; G05D 1/0297; G05D 1/0285; G05D 2201/0212; G07C 5/02; G01C 21/343; G08G 1/202; G07C 5/08; G05D 1/0088

(57) ABSTRACT

The present invention relates to scheduling systems. In particular, the present invention relates to autonomous transportation scheduling. More specifically, the present invention relates to novel improvements in transportation planning and allocation of resources on an autonomous dynamic basis including a dynamic autonomous scheduling transportation system including a passenger interface, an optimization engine electronically attached to the passenger interface for readily producing a new schedule, and a transportation means electronically attached to the optimization engine and responsive to input from the passenger interface.

### FIELD OF THE INVENTION

The present invention relates to scheduling systems. In particular, the present invention relates to autonomous transportation scheduling. More specifically, the present invention relates to novel improvements in transportation planning and allocation of resources on an autonomous dynamic basis.

### BACKGROUND OF THE INVENTION

The introduction of autonomous vehicles will revolutionize transportation in general, and public transportation in particular.

With the obviation of the need for a human driver, public transportation operational costs will decrease, and the use of public transport will be popularized over the need to maintain a (costly) private vehicle.

Reduced operational cost will also allow companies which provide transport services greater flexibility in both timetables and routes, offering customized service which is dictated by the client demands, state of traffic and other irregular events.

Nevertheless, increased flexibility may result in expensive inefficiency, or in implementation difficulties. Invariably, companies will need to make use of optimization engines, in attempting to reduce potentially enormous costs, while maintaining a high service quality for a fixed size fleet of vehicles.

A further possible attempt to address such issues with current systems known in the art would include continuing with existing schedules, as designed for non-autonomous vehicles with constraints that are relevant for human drivers, making these schedules outdated and wasteful.

A still further possible attempt to address such issues with current systems known in the art would include maintaining a pre-assigned, fixed schedule where changes will be avoided. Such an attempt would ignore new types of available data, thereby increasing operational costs and reducing service optimality and potential profit.

Yet a further possible attempt to address such issues with current systems known in the art would include updating schedules manually, enabling a certain degree of flexibility. However, without a comprehensive optimization engine, the full calculation of the costs is not possible, and on a large scale, inefficiencies are bound to occur and greatly increase operational costs.

Attempting to assign vehicle per demand as happens in current days taxis services would invariably face all the known deficiencies of unplanned unfixed schedules and high working costs.

According to contemporary teachings of the art, vehicles are operated by a human driver. The need for a human driver imposes various rules and regulation on scheduling processes, such as a requirement for breaks, depot assignment and a limited number of alterations which can be performed to a pre-assigned schedule.

Furthermore, in existing systems known in the art the scheduler's ability to process information from various input sources is limited at best. Moreover, the scheduler has limited control over drivers and vehicles.

The systems known in the art rely on verbal communication with the driver, and must make sure the driver understands the new instructions.

A latent deficiency of these systems is the inherent limited flexibility of the schedule which highly limits ability to address unexpected scheduling problems.

Furthermore, schedule optimizing engines today output results on a timescale of hours to days from query, which lead to mid-day schedule modifications becoming undesirable if not insurmountable.

Due to the lengthy processing requirements of current schedule optimizing engines, adjustment in an existing schedule for a specific day, often cannot be calculated using an optimization engine, and may result in expensive inefficiencies.

Once autonomous vehicles become more widely used in public transportation, companies which continue operating their fleet as if a driver was still assigned to a vehicle, will not be able to make use of the potential flexibility advantages as well as omit factors which are driver sensitive such as breaks and the like.

In view of the amount of data required for scheduling expanding rapidly there is therefore a need for a dynamic autonomous scheduling system capable of taking advantage of the proposed information and readily facilitating predictions of customer behavior, nearby transportation systems, trips, demands and other types of valuable features of the dynamic autonomous scheduling transportation system.

The dynamic autonomous scheduling would preferably process data from several different sources of information, including but not limited to at least a plurality of components selected from the group: at least one GPS system located at the service provider fleet of transportation means, an onboard transportation means systems for monitoring passenger occupancy, at least one street stops monitor to report pas for ascertaining occupancy of passengers, at least one report including traveling/waiting passengers, at least one End-user application for relaying customer service demands, a traffic monitoring system, at least one local/national media report on transportation events such as traffic jams, weather reports or other unique events influencing transportation patterns as well as traffic flow and an efficient rapid optimization engine regularly updated with data and capable of handling large-scale volumes of data an, implement calculations accordingly.

### SUMMARY OF THE INVENTION

The present invention is a dynamic autonomous scheduling transportation system.

### BRIEF DESCRIPTION OF THE DRAWINGS

FIG. 1 is a block diagram view of the dynamic autonomous scheduling transportation system according to the present invention.

### DETAILED DESCRIPTION OF THE INVENTION

The dynamic autonomous scheduling transportation system according to the present invention, as described herein, processes data from several different sources of information, including but not limited to at least a plurality of components selected from the group: at least one GPS system located at the service provider fleet of transportation means, an onboard transportation means systems for monitoring passenger occupancy, at least one street stops monitor to report pas for ascertaining occupancy of passengers, at least one report including traveling/waiting passengers, at least one End-user application for relaying customer service demands, a traffic monitoring system, at least one local/national media report on transportation events such as traffic jams, weather reports or other unique events influencing transportation patterns as well as traffic flow and an efficient rapid optimization engine regularly updated with data and capable of handling large-scale volumes of data and implement calculations accordingly.

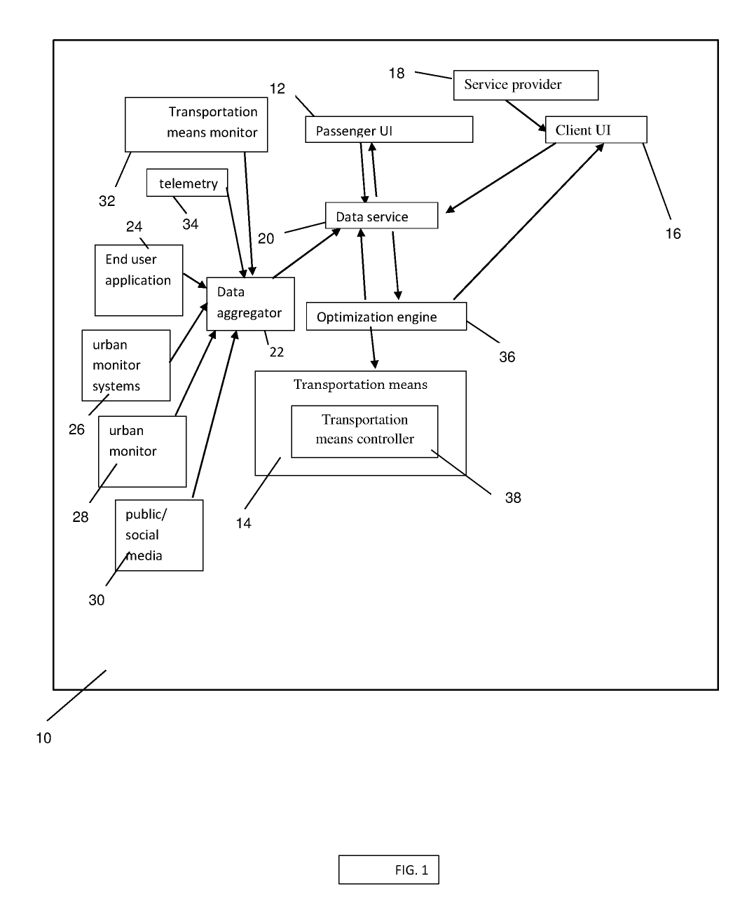

As shown in FIG. 1, a dynamic autonomous scheduling transportation system 10 includes a passenger interface 12.

Preferably, passenger interface 12 readily facilitates at least one end-users to send trip requests.

Preferably, passenger interface 12 readily facilitates updating end-users with at least one data selected from the group consisting of: an estimated time of arrival of a transportation means 14, a current geographical location of transportation means 14, a current price for using transportation means 14 and alternative transportation means 14.

Dynamic autonomous scheduling transportation system 10 preferably also includes a client interface 16, readily facilitating a service provider 18 to input variables to dynamic autonomous scheduling transportation system 10 including but not limited to preferences, trip requests, constraints and the like.

Client interface 16 preferably outputs the schedule to service provider 18. Preferably, output from client interface 16 is in a Gantt form.

Dynamic autonomous scheduling transportation system 10 preferably also includes a data set service 20. Preferably, data set service 20 includes, but is not limited to at least one trip to be scheduled, at least one end user preference entered by way of passenger user interface 12, a transportation means 14 constraint and current state of at least one transportation means 14 including but not limited to location, as provided by GPS, and telemetry data of transportation means 14. The dataset from data set service 20 may be updated by requests for trip from the end-user through passenger user interface 12 or service provider 18, and continuously updated by the data collector systems.

Preferably, a data aggregator 22 to aggregate, into the dataset, additional information from several sources including but not limited to at least one end users application 24, transportation means 14, a monitor system 26, an urban monitor systems 28, at least one public/social media source 30, a transportation means monitor 32 of transportation means 14.

Preferably, transportation means monitor 32 readily provides telemetry data from at least one telemetry sensor 34 on transportation means 14.

Dynamic autonomous scheduling transportation system 10 also includes a server (optimization engine) 36 for readily ascertaining and finding improved solutions to the scheduling constraints taking under consideration all the required trip demands and operator preferences as given at the dataset on a specific time.

Preferably, optimization engine 36 ascertains and finds an optimal solution to the scheduling constraints taking under consideration all the required trip demands and operator preferences as given at the dataset on a specific time.

Preferably, a transportation means control unit 38 is provided for delivering driving instructions to transportation means 14.

Preferably, transportation means control unit 38 implements the proposed schedule and directs the driver of at least one manned transportation means 14 and/or at least one unmanned transportation means 14 accordingly.

Transportation means control unit 38 is preferably automatic. Alternatively, transportation means control unit 38 requires input from client interface 16, depending on client preference.

Preferably, for the purpose of dealing with communication systems failure situations while dynamic autonomous scheduling transportation system 10 is running, dynamic autonomous scheduling transportation system 10 stores (in each transportation means 14 locally) several schedules to be operated under these circumstances.

Substantially subsequently to a transportation means 14 completing a task, at least one schedule is selected depending on the geographic current position of transportation means 14.

Preferably, dynamic autonomous scheduling transportation system 10 updates on a daily/weekly/other basis at least one possible schedule.

Preferably, dynamic autonomous scheduling transportation system 10 updates at least one schedule according to the last trip demands which existed prior to update.

By following this schedule dynamic autonomous scheduling transportation system 10 meets the most common trips demand pattern of the last prescribed time period.

Preferably, as communication returns, dynamic autonomous scheduling transportation system 10 optimizes the fleet schedule of transportation means 14 again substantially towards optimality according to the current position and occupancy of the fleet, stations and current trip demands.

Given a fleet of autonomous transportation means 14, along with a list of trips requested by customers, dynamic autonomous scheduling transportation system 10 creates a schedule for transportation means 14 with a substantially minimal operational cost.

Preferably, optimization engine 36 performs an optimization according to the following variables.

An energy consumption, according to the mileage that transportation means 14 needs to travel and the time duration of trips, a successful optimization reduces “idle” trips between customer paid routes and, client satisfaction permitting, unites trips together, thereby “sharing” a part of the trip together and suggests optimal pricing between customers.

A Client satisfaction framework calculating the time it takes for a client to arrive at a destination thereby readily facilitating precision in departure/arrival times. Precision in departure/arrival times are the main keys to high client satisfaction with transportation services.

Clients may also specify certain preferences they have regarding the transportation service, such as whether it is possible to share part of the route with other customers, how much of a delay they are willing to accept, what are the time frames on which they can be available for collection/dispatch, the types of transportation means 14 they wish to pick them up, types/size of luggage to be transferred and the like.

For the purpose of attaining a commercial advantage, dynamic autonomous scheduling transportation system 10 calculates and factors client demands and thereby verifying a high satisfaction rate.

Preferably, for the purpose of attaining a commercial advantage, dynamic autonomous scheduling transportation system 10 also suggests alternatives that are reflected through changes in the trip pricing.

Preferably, dynamic autonomous scheduling transportation system 10 utilizes past data to pre-calculate a recommended fleet size including, the number of transportation means 14 that may be used, and may be flexed within certain cases (such as transportation means 14 needed to be “borrowed” or “loaned” to and from other companies).

Preferably, dynamic autonomous scheduling transportation system 10 detects an occurrence wherein transportation means 14 incurs a technical malfunction.

Preferably, occasioning on dynamic autonomous scheduling transportation system 10 detecting a technical malfunction, dynamic autonomous scheduling transportation system 10 remove faulty transportation means 14 from the fleet for the rest of the day and\or until an indication the malfunction is resolved, distributing the trips of faulty transportation means 14 among the rest of the fleet.

Preferably, dynamic autonomous scheduling transportation system 10 is geared towards resolving unexpected events. Often, not all trip requests will be given in advance, and/or various unexpected delays may also appear. Thus, data is continuously updated and allow modifications when needed by dynamic autonomous scheduling transportation system 10.

Preferably, dynamic autonomous scheduling transportation system 10 readily utilizes large amounts of additional information to predict customer demands, transportation necessary schedule changes and additional influential events.

Preferably, dynamic autonomous scheduling transportation system 10 outputs the suggested schedule on a timescale of minutes, readily facilitating the service to be responsive to fluctuating demands.

Preferably, dynamic autonomous scheduling transportation system 10 utilizes continuous, combinatorial and additional optimization algorithms and modifications on a given schedule. Thus, dynamic autonomous scheduling transportation system 10 readily provides highly efficient results.

Substantially thereafter, dynamic autonomous scheduling transportation system 10 redirects transportation means 14 automatically via communication controllers.

Alternatively, substantially thereafter, dynamic autonomous scheduling transportation system 10 passes at least one suggestion to the service providers 18, which service providers 18 will implement the changes as they see fit.

Dynamic autonomous scheduling transportation system 10 readily achieves cost effectiveness by having a successful optimization process done by optimization engine 36.

According to a preferred exemplary solution, optimization engine 36 processes trip requests from data service 20, and represents them as a graph.

Substantially thereafter, optimization engine 36 creates a non-optimized initial solution of either predetermined transportation means 14 routes and times, a solution where each trip with its own transportation means 14, or a current transportation means 14 trips allocations scheme (in cases where additional solutions were just updated).

Preferably, substantially subsequently, optimization engine 36 implements methods of local search to reorganize the routes and times in a way compatible with customer requests and operationally efficient.

Thus, optimization engine 36 can readily insert a change into the schedule, and if the algorithmic cost of the schedule (representing a mixture of operational cost and customer satisfaction) is reduced, the change is accepted. This process will be done iteratively until a sufficiently efficient schedule is received.

Optionally, optimization engine 36 substantially achieves optimality by way of using use max-flow algorithms, column generation and constraint programming methods.

Preferably, optimization engine 36 utilizes machine learning and neural network architecture for studying model schedules and incorporating the data to build high-quality schedules in an accurate and fast implementation.

Preferably, optimization engine 36 readily collects a large amount of data in the dataset from different sources (as described herein). Several features will be extracted from this data using big data and data mining algorithms. Preferably, optimization engine 36 includes a machine learning module for that purpose.

For the purpose of providing an exemplary non-limiting operation, during a mid-day operation of a schedule, transportation means monitor 32 sends to data set service 20 information of a fault such as a small engine coolant leak in a certain transportation means 14. Dynamic autonomous scheduling transportation system 10 responsively deduces that transportation means 14 may not be used further during a specific time frame, and substantially thereafter, dynamic autonomous scheduling transportation system 10 instructs transportation means 14 to drive to the repair shop mechanic to be repaired right after its current trip.

Occasioning on transportation means 14 not being fit to return to service for the rest of the time frame, optimization engine 36 recalculates an efficient way to distribute the trips of malfunctioning transportation means 14 to other transportation means 14 in the fleet, and instructs the transportation means 14 fleet to follow the new schedule plan.

For the purpose of providing an additional exemplary non-limiting operation, an integration of information from several transportation means 14 performing line ‘101’ reveals that this line is continuously crowded, especially between station A, where a lot of passengers board the transportation means 14, and station B, where most of these people drop off. Street data collection systems reveal a heavy crowd in station A, waiting to be picked up. The optimization engine then determines whether it can use a spare transportation means 14, or reroute another transportation means 14, and creates a Shuttle line straight from station A to station B. The instructions are transmitted to this spare transportation means 14, which begins the task, enabling the service provider to meet the demand for that route.

For the purpose of providing a further exemplary non-limiting operation, data collected from the urban traffic control systems point out that the junction of two main streets is flooded and shall be closed off for constructions for the next 24 hours. Dynamic autonomous scheduling transportation system 10 responsively sends instructions to all transportation means 14 in the area and updates their schedule to avoid the traffic block by minimizing passenger dissatisfaction. Passengers might depart closely to their destination or picked up by an available close by transportation means 14.

The term “transportation means” as used herein, shall include but will not be limited to: a means of conveyance or travel from one place to another including a vehicle or system of vehicles, such as a bus, a train, a ship, a boat, a taxi, a car, an automobile, a truck, a van, a single, two and three wheeled vehicle, a sea vessel, an aircraft or an airborne carrier, a drone or other unmanned flying object, a non wheeled vehicle like a motorized snow sled or snowmobile and the like for private and public conveyance of passengers or goods especially as a commercial enterprise, a means of transportation, a controller of a means of transportation, a bank energy resource for a means of transportation, a loading station for loading a means of transport, an off-loading station for off-loading a means of transport and the like.

The term “telemetry data” as used herein, shall include but will not be limited to, at least one parameter selected from the group consisting of: a weather condition, a raw positioning data, a speed, a tire pressure, a fuel content, an oil content, a hydraulic pressure, an oil pressure, a G force in 3 axis, a tire rate of deterioration, an acceleration rate, an oil temperature, a water temperature, an engine temperature, a wheel speed, a suspension displacement, controller information, a two way telemetry transmission for remote updates, calibration and adjustments of a component of transportation means, expected tire change required, expected refueling required and an expected servicing required.

It will be appreciated that the above descriptions are intended to only serve as examples, and that many other embodiments are possible within the spirit and scope of the present invention.

What is claimed is:

1. A dynamic autonomous scheduling transportation system comprising:
(a) a passenger interface;
(b) an optimization engine electronically attached to said passenger interface for readily producing a new schedule; and
(c) a transportation means electronically attached to said optimization engine and responsive to input from said passenger interface.

2. The dynamic autonomous scheduling transportation system of claim 1, further comprising a dataset service including at least one parameter selected from the group consisting of: a plurality of tasks, a passenger request, a history dataset containing the actual travel time of historical trips, a prediction model, a planning constraint and a planning preference.

3. The dynamic autonomous scheduling transportation system of claim 2, wherein said client interface further comprises a transportation means controller.

4. The dynamic autonomous scheduling transportation system of claim 3, wherein said optimization engine is responsive to a set of telemetry data, wherein telemetry data includes at least one parameter selected from the group consisting of: a weather condition, a raw positioning data, a speed, a tire pressure, a fuel content, an oil content, a hydraulic pressure, an oil pressure, a G force in 3 axis, a tire rate of deterioration, an acceleration rate, an oil temperature, a water temperature, an engine temperature, a wheel speed, a suspension displacement, controller information, a two way telemetry transmission for remote updates, calibration and adjustments of a component of transportation means, expected tire change required, expected refueling required and an expected servicing required.

5. The dynamic autonomous scheduling transportation system of claim 1, further comprising an optimization engine for readily “preempting” an event based on statistical modules processing a stream of data, a sensor reading and/or a learning process of said prediction engine.

6. The dynamic autonomous scheduling transportation system of claim 5, wherein said optimization engine is responsive to signals from said passenger interface.

7. A dynamic autonomous scheduling transportation system comprising:
(a) a passenger interface for readily updating at least one end-user;
(b) an optimization engine electronically attached to said passenger interface responsive to signals from said passenger interface; and (c) an unmanned transportation means electronically attached to said optimization engine and responsive to input from said passenger interface.

8. The dynamic autonomous scheduling transportation system of claim 7, further comprising a dataset service including at least one parameter selected from the group consisting of: a plurality of tasks, a passenger request, a history dataset containing the actual travel time of historical trips, a prediction model, a planning constraint and a planning preference.

9. The dynamic autonomous scheduling transportation system of claim 8, wherein said client interface further comprises a transportation means controller.

10. The dynamic autonomous scheduling transportation system of claim 9, wherein said optimization engine is responsive to a set of telemetry data, wherein telemetry data includes at least one parameter selected from the group consisting of: a weather condition, a raw positioning data, a speed, a tire pressure, a fuel content, an oil content, a hydraulic pressure, an oil pressure, a G force in 3 axis, a tire rate of deterioration, an acceleration rate, an oil temperature, a water temperature, an engine temperature, a wheel speed, a suspension displacement, controller information, a two way telemetry transmission for remote updates, calibration and adjustments of a component of transportation means, expected tire change required, expected refueling required and an expected servicing required.

11. The dynamic autonomous scheduling transportation system of claim 7, further comprising an optimization engine for readily “preempting” an event based on statistical modules processing a stream of data, a sensor reading and/or a learning process of said prediction engine.

12. The dynamic autonomous scheduling transportation system of claim 7, further comprising a client interface for readily facilitating a service provider to input variables to an optimization engine.

13. The dynamic autonomous scheduling transportation system of claim 12, further comprising a dataset service including at least one parameter selected from the group consisting of: a plurality of tasks, a passenger request, a history dataset containing the actual travel time of historical trips, a prediction model, a planning constraint and a planning preference.

14. The dynamic autonomous scheduling transportation system of claim 13, wherein said client interface further comprises a transportation means controller.

15. The dynamic autonomous scheduling transportation system of claim 14, wherein said optimization engine is responsive to a set of telemetry data, wherein telemetry data includes at least one parameter selected from the group consisting of: a weather condition, a raw positioning data, a speed, a tire pressure, a fuel content, an oil content, a hydraulic pressure, an oil pressure, a G force in 3 axis, a tire rate of deterioration, an acceleration rate, an oil temperature, a water temperature, an engine temperature, a wheel speed, a suspension displacement, controller information, a two way telemetry transmission for remote updates, calibration and adjustments of a component of transportation means, expected tire change required, expected refueling required and an expected servicing required.

16. The dynamic autonomous scheduling transportation system of claim 7, wherein said optimization engine readily “preempts” an event based on statistical modules processing a stream of data, a sensor reading and/or a learning process of said prediction engine.

17. The dynamic autonomous scheduling transportation system of claim 8, further comprising a data aggregator for readily aggregating into said dataset, at least one additional information selected from the group consisting of: at least one end users application, said transportation means, a monitor system, an urban monitor systems, at least one public/social media source and a transportation means monitor of said transportation means.

18. The dynamic autonomous scheduling transportation system of claim 17, wherein said transportation means further comprises at least one telemetry sensor for readily providing telemetry data.

19. The dynamic autonomous scheduling transportation system of claim 18, wherein said optimization engine readily calculates improved solutions to at least one scheduling constraints and taking under consideration at least one required trip demand and at least one operator preference.

20. The dynamic autonomous scheduling transportation system of claim 7, further comprising:
(d) a transportation means control unit for delivering driving instructions to said transportation means and wherein said transportation means control unit implements a proposed schedule and directs said unmanned transportation means accordingly and wherein said transportation means control unit requires input from said client interface, depending on client preference.
